(19) United States
(12) Patent Application Publication
(10) Pub. No.: US 2012/0115997 A1
(43) Pub. Date: May 10, 2012

(54) PROCESS FOR PRODUCTION OF POLYESTERS

(75) Inventors: Clive Alexander Hamilton, Swainby (GB); Robert Edward Neate, Guisborough (GB); Catherine Jane Coleman, Darlington (GB)

(73) Assignee: INVISTA NORTH AMERICA S.A R.L., Wilmington, DE (US)

(21) Appl. No.: 13/057,563

(22) PCT Filed: Jul. 31, 2009
(86) PCT No.: PCT/GB09/01900

§ 371 Date: Apr. 6, 2011

Related U.S. Application Data
(60) Provisional application No. 61/086,982, filed on Aug. 7, 2008.

(51) Int. Cl. C08K 5/521; C08K 5/524

(52) U.S. Cl. 524/139; 524/145

(57) ABSTRACT

The present invention relates to a process for producing a polyester comprising: (a) forming a polyester with an intrinsic viscosity of at least about 0.65, wherein said forming of the polyester comprises use of a catalyst; and (b) adding a phosphorous compound to the polyester after the forming of step (a), wherein said phosphorous compound comprises at least one member selected from the group consisting of trialkyl phosphate, trialkyl phosphonoacetate, monoalkyl phosphate, dialkyl phosphate, trialkyl phosphite, triaryl phosphite, tris alkylaryl phosphite, and mixtures thereof. The present invention also includes compositions produced by process of the present invention and articles comprising those compositions.

### FIELD OF THE INVENTION

The present invention relates to processes for manufacture of polyester having low acetaldehyde content.

### BACKGROUND OF THE INVENTION

Polyester resin, for example polyethylene terephthalate (PET), is typically manufactured using a process whereby a base polyester is made in a melt phase polymerisation (MPP) process and optionally followed by a solid state polymerisation (SSP) process. The MPP can be further sub-divided into two more stages namely i) the esterification process in which the esterification reactions are typically taken to around 95% conversion, and ii) the melt phase polycondensation process where the conversion is increased to over 99%. In order to achieve reasonable yields polycondensation catalysts are employed. Typical polycondensation catalysts include antimony (Sb), titanium (Ti), zinc (Zn), and germanium (Ge). These are added to the MPP to catalyze the polycondensation reaction. The catalysts are typically added either to the esterification process or just before the polycondensation process.

In conventional polyester manufacture, phosphorous compounds are typically added during the MPP to stabilize the polymer against (i) thermal degradation in the polymer transfer line from the finishing reactor to the chipper, (ii) thermo-oxidative degradation in SSP, and (iii) thermal degradation during the injection moulding process. These thermal degradation reactions result in the formation of acetaldehyde (AA). Acetaldehyde is routinely measured in the base polymer, the final product chip and more importantly in the injection moulded preform. The formation of the AA by-product is catalysed by the polycondensation catalysts and hence phosphorous compounds tend to be used to control its final value.

Phosphorous compounds are typically added either during or immediately after the esterification step of the MPP, for example as described in U.S. Pat. No. 5,235,027. Sometimes phosphorous compounds are added later in the process. For example, U.S. Pat. No. 5,898,058 describes late addition of general organophosphorous compounds. Late addition of general acidic phosphorous compounds is described in US 2006/0287472. Finally, late addition of phosphorous-containing acid salts of amines is described in US 2007/0066794.

Unfortunately, polyester manufactured using late addition of the above generally described phosphorous compounds can still have unacceptably high AA content in the preform. Therefore, a need exists for improved AA regeneration control and reduced AA content in a polyester resin.

### SUMMARY OF THE INVENTION

In accordance with the present invention, it has now been found that late addition of certain phosphorous compounds in a polyester process unexpectedly improves i) the AA content in the preform, and ii) the thermal stability of the resins and product, which thus can improve the color. The improvement of the AA content in the preform is achieved without the need for an AA scavenger. The present invention relates to a process for producing a polyester comprising: (a) forming a polyester with an intrinsic viscosity of about 0.65 or more, wherein said forming of the polyester comprises use of a catalyst; and (b) adding a phosphorous compound to the polyester after the forming of step (a), wherein said phosphorous compound comprises at least one member selected from the group consisting of trialkyl phosphate, trialkyl phosphonoacetate, monoalkyl phosphate, dialkyl phosphate, trialkyl phosphite, triaryl phosphite, tris alkylaryl phosphite, and mixtures thereof. The present invention also includes compositions produced by process of the present invention and articles comprising those compositions.

### DETAILED DESCRIPTION OF THE INVENTION

The present invention can be characterized by a process for producing a polyester comprising: (a) forming a polyester with an intrinsic viscosity of about 0.65 or more, wherein said forming of the polyester comprises use of a catalyst; and (b) adding a phosphorous compound to the polyester after the forming of step (a), wherein said phosphorous compound comprises at least one member selected from the group consisting of trialkyl phosphate, trialkyl phosphonoacetate, monoalkyl phosphate, dialkyl phosphate, trialkyl phosphite, triaryl phosphite, tris alkylaryl phosphite, and mixtures thereof. The phosphorous compound can be at least one member selected from the group consisting of tributyl phosphate, triethyl phosphate, triethyl phosphonoacetate, monoethyl phosphate, diethyl phosphate, triethyl phosphite, triphenyl phosphite, tris nonylphenyl phosphite, and mixtures thereof, for example at least one member selected from the group consisting of triphenyl phosphite, triethyl phosphite, triethyl phosphonoacetate and mixtures thereof. The phosphorous compound is not an acidic compound or a salt.

The catalyst can be at least one member selected from the group consisting of antimony, titanium, cobalt, germanium, aluminum, tin, zinc and mixtures thereof or at least one member selected from the group consisting of titanium, cobalt, germanium, aluminium, tin, zinc and mixtures thereof. The catalyst can be at least one member selected from the group consisting of titanium, cobalt, zinc and mixtures thereof, for example a mixture of titanium and zinc. The weight ratio of titanium to zinc can be in the range of from about 1:60 to about 1:2, for example about 1:20 to about 1:3 or about 1:10 to about 1:3.5. The catalyst can be present at a concentration in the range of from about 3 ppm to about 250 ppm by weight of the polyester, for example titanium can be present at a concentration in the range of from about 3 ppm to about 20 ppm by weight of the polyester or zinc can be present at a concentration in the range of from about 60 ppm to about 250 ppm by weight of the polyester.

The phosphorous compound and the catalyst can be present at a weight phosphorous compound to weight catalyst ratio in the range of from about 0.5:1 to about 5.75:1, for example in the range of from about 0.5:1 to about 4:1 or about 0.75:1 to about 1.5:1, or a weight phosphorous compound to weight catalyst ratio of about 1:1.

The intrinsic viscosity can be about 0.65 or more, for example about 0.70 or more, about 0.75 or more or about 0.80 or more. The forming of step (a) can comprise melt phase polymerization, for example the forming of step (a) can be not by solid state polymerization. The polyester can have an L* of about 50 or more, for example about 54 or more, after the adding of step (b).

The process of the present invention can further comprise adding a reheat agent to the polyester. The reheat agent can be at least one member selected from the group consisting of carbon black, graphite, infra-red dye, metal particle and mixtures thereof, for example the reheat agent can be at least one member selected from the group consisting of antimony, titanium, copper, manganese, iron, tungsten and mixtures thereof. The reheat agent can be present in a concentration range of from about 0.5 ppm to about 20 ppm.

Generally, the polyester can be produced from an aromatic dicarboxylic acid or an ester-forming derivative and glycol as starting materials. Examples of the aromatic dicarboxylic acid used in the present invention include terephthalic acid, isophthalic acid, 2,6-naphthalenedicarboxylic acid, phthalic acid, adipic acid, sebacic acid and mixtures thereof. The aromatic acid moiety can be at least 85 mole % of terephthalic acid. Examples of the glycol that can be used in the present invention include ethylene glycol, butanediol, propylene glycol, and 1,4-cyclohexanedimethanol, and mixtures thereof. The primary glycol can be at least 85 mole. % of ethylene glycol, butanediol, propylene glycol or 1,4-cyclohexanedimethanol.

Transesterification of the ester derivative of the aromatic acid, or direct esterification of the aromatic acid with the glycol can be used in the present invention. After polymerization to the desired IV, the polyester typically can be pelletised, dried and crystallized.

The polyester can be selected from the group consisting of polyethylene terephthalate, polybutylene terephthalate, polypropylene terephthalate, poly (1,4 cyclohexylene-dimethylene) terephthalate, polyethylene naphthalate, polyethylene bibenzoate, and copolyesters of these. For example, the polyester can be i) a polyethylene terephthalate, or a copolyester of polyethylene terephthalate with up to 20 wt-% of isophthalic acid or 2,6-naphthoic acid, and up to 10 wt-% of diethylene glycol or 1,4-cyclohexanedimethanol, ii) a polybutylene terephthalate, or a copolyester of polybutylene terephthalate with up to 20 wt-% of a dicarboxylic acid, and up to 20 wt-% of ethylene glycol or 1,4-cyclohexanedimethanol, or iii) a polyethylene naphthalate, or a copolyester of polyethylene naphthalate with up to 20 wt-% of isophthalic acid, and up to 10 wt-% of diethylene glycol or 1,4-cyclohexanedimethanol.

An embodiment of the present invention can be as follows. A 2:1 terephthalic acid (TA): ethylene glycol (EG) slurry can be injected into a natural thermosyphon esterifer operating at atmospheric pressure with a residence time of about two hours and a temperature range of about 280° C. to about 290° C. Ethylene glycol, cobalt acetate (for example not more than about 150 ppm) and a titanium catalyst (for example not more than about 50 ppm Ti) can be added to an oligomer line between the esterifier and the pre-polymeriser. The pre-polymeriser can be a vertical staged reactor or upflow pre-polymeriser (UFPP) operating under a vacuum in the range of about 20 mmHg to about 30 mmHg. The reactor residence time can be of the order of about one hour while operating in a temperature range of about 270° C. to about 290° C. The reaction products of the pre-polymeriser can then pass to a horizontal wiped-wall finisher operating under vacuum-viscosity control in a temperature range of about 270° C. to about 290° C. with a residence time of about one to about two hours. The IV target for this vessel can be about 0.5 dl/g to about 0.65 dl/g and the vessel can have a vacuum of between about 1 mmHg and about 4 mmHg. Finally the polymer can pass through a horizontal wiped-wall post finisher operating under vacuum-viscosity control in a temperature range of about 270° C. to about 290° C. with a residence time of about one to about two hours. The IV target for this vessel can be about 0.7 dl/g to about 0.9 dl/g and the vessel can have a vacuum of between about 0.5 mmHg and about 2 mmHg. Phosphorous compounds can then be injected into the post finisher transfer line downstream of the polymer pump but upstream of the polymer filter and chippers. Once the polymer has been solidified and made into particles (chips) it can then undergo a crystallisation/de-aldehydisation process (deAA) whereby the chip crystallinity can be increased to at least about 35% (calculation from delta H (fusion)) and the residual aldehyde content can be reduced to less than about 1 ppm (to be equivalent with conventional SSP chip).

The addition of a variety of additives is also within the scope of the present invention. Accordingly, heat stabilizers, anti-blocking agents, antioxidants, antistatic agents, UV absorbers, toners (for example pigments and dyes), fillers, branching agents, and other typical agents can be added to the polymer generally during or near the end of the polycondensation reaction. Conventional systems can be employed for the introduction of additives to achieve the desired result.

The present invention includes a polyester composition produced by the process described above. For example, a polyester composition comprising a phosphorous compound comprising at least one member selected from the group consisting of trialkyl phosphate, trialkyl phosphonoacetate, monoalkyl phosphate, dialkyl phosphate, trialkyl phosphite, triaryl phosphite, tris alkylaryl phosphite, and mixtures thereof. The polyester composition can also further comprise an acetaldehyde concentration of 3 ppm or less by weight.

The present invention also includes articles made from compositions produced by the process described above. Articles can be pellets, chips, sheets, films, fibers or injection molded articles such as performs and containers, for example bottles.

As used in this specification and unless otherwise indicated the term “alkyl” refers to straight or branched chains of at least two carbon atoms and up to twelve carbon atoms, for example up to ten carbon atoms or up to seven carbon atoms. The term “aryl” refers to an aromatic ring structure, including fused rings, having four to ten carbon atoms.

### Test Methods

Measurement of Intrinsic Viscosity in Polyethylene Terephthalate—Intrinsic Viscosity (IV) of the polyester was measured according to ASTM D4603-96.

Measurement of Carboxyl End-Groups in Polyethylene Terephthalate—The method for the determination of carboxyl end-groups involves the addition of a measured excess of ethanolic sodium hydroxide to a solution of the polyester in o-cresol/chloroform and the potentiometric titration (using Metrohm 716 Titrino) of the excess. The titration was automatic, the titrant being added at a known rate over a period of 10-20 minutes.

Measurement of Diethylene Glycol Groups in Polyethylene Terephthalate by Gas Chromatography—The polymer sample was hydrolysed by agitation under reflux with potassium hydroxide in propan-1-ol in the presence of a known concentration of the internal standard (butane 1:4 diol). The hydrolysate was cooled, neutralised with powdered terephthalic acid and the clarified liquor subjected to a gas chromatograph (Perkin Elmer Autosystem GC fitted with a flame ionisation detector, on column injection facility, PSS injector and configured with capillary column parameters. The peak area ratio of the diethylene glycol to the internal marker was obtained from the chromatogram. The results were calculated by reference to a calibration factor and are reported to the nearest 0.01% w/w.

Measurement of Acetaldehyde Level in Polyethylene Terephthalate Chip and Preforms by Thermal Desorption Gas Chromatography. The sample was ground to a powder, weighed and packed into a thermal desorption tube. Acetaldehyde was desorbed from the sample by heating the tube at 160° C. with a stream of nitrogen passing through the sample for 10 minutes. The acetaldehyde was held in a cold trap and released into the chromatograph after the 10 minute desorption period. The acetaldehyde was analysed on a Gas Chromatograph Perkin Elmer 8000 system comprising a column packed with Porapak “QS” and a flame ionisation detector. Quantification was carried out by measurement of peak areas and relating to those of appropriate standards to obtain ppm w/w acetaldehyde based on the weight of polymer taken for desorption.

Measurement of Element content in Polyethylene Terephthalate—The element content of the polymer sample was measured with a SpectroFlame Modula E inductively coupled plasma—atomic emission spectrometer (ICP/AES) manufactured by Spectro GmbH, Germany. The sample was dissolved by microwave assisted digestion in a 1:1 mixture of concentrated sulfuric acid and concentrated nitric acid. After cooling, the digestion was diluted with pure water and subsequently analyzed. Comparison of atomic emissions from the sample under analysis with those of certified standard solutions of known metal ion concentrations was used to determine the experimental values of metals retained in the polymer sample.

Measurement of Vinyl-End Groups in Polyethylene Terephthalate—This was done by NMR analysis by a third party (Intertek MSG, UK).

Measurement of Color was defined in CIE or Hunter units of L*, a* and b*, whereby a* color quantifies red-green hue, b* color quantifies yellow-blue hue and L* color quantifies darkness to lightness.

### EXAMPLES

The following examples were run on a 1 metric tonne per day continuous pilot line facility incorporating four reactors with multiple inter-vessel additive injection points and a post-finisher transfer line injection point.

Unless otherwise specified, in all the examples: The first reactor or primary esterifier (PE) was fed with a 1.1:1 terephthalic acid (TA): ethylene glycol (EG) paste, operated at supra-atmospheric pressures with a reactor residence time of about two hours and a temperature range of 255° C. to 270° C. The second reactor or secondary esterifier (SE) had a residence time of about one hour, operated at atmospheric pressure and a temperature range of 260° C. to 280° C. The third reactor or low polymeriser (LP) was operated under sub-atmospheric pressures of about 50 mBara, had a residence time of about 40 minutes and operated in the temperature range of 270° C. to 285° C. The final reactor or high polymeriser (HP) operated under vacuum control whereby the operating pressure was dictated by the viscosity of the final product, typically this was about 1 mBara. The final reactor residence time was about one hour and operated in a temperature range of 270° C. to 285° C. Late addition phosphorus compounds were added into the polymer transfer line between the final reactor and the underwater strand cutter.

Unless otherwise specified, in all examples: The primary esterifier was a forced recirculating vessel with a rectification column overhead. Ethylene glycol (EG) vapour was condensed in the rectification column and returned to the vessel. Water vapour passed through the column and was subsequently condensed thereby driving the esterification reaction to around 90% completion. The remaining reactors were horizontal wiped-wall vessels from which the EG and water vapours were condensed and either recirculated to paste formation or collected for disposal.

Unless otherwise specified, in all examples: The polyester resin made as outlined above was then precrystallised in an air oven for about 20 minutes at about 170° C. then de-aldehydised at about 175° C. in air for about six hours during which time the chip crystallinity increased to more than 35% (calculation from delta H (fusion)) and the residual aldehyde content fell to less than 1 ppm. Alternatively the polymer can be de-AA'd in a nitrogen driven fluid bed or in a commercial-scale recirculating air oven.

The resulting polymer in each example was subjected to various standard PET analytical measurements including intrinsic viscosity (IV), carboxyl end group analysis (COOH), diethylene glycol analysis (DEG), ICP elemental analysis for metals, chip AA analysis and vinyl-end group analysis (VEG).

The polymer was also injection moulded into preforms using two different pieces of industrial scale equipment, either an Arburg or an Negro Bossi (NB90). The Arburg preform moulding equipment was a single cavity machine with a 270° C. moulding temperature with a cycle time of about 23 seconds. The NB90 preforom moulding equipment was a single cavity machine with a 275° C. moulding temperature with a cycle time of about 43 seconds. The preform AA was measured using one or both of these machines and recorded.

### Comparative Example 1

In this example a preform AA value was established using an antimony catalyst system without late addition of phosphorous (P) and a polymer throughput/flow rate of 50 kg/hour. A phosphorous compound in the form of phosphoric acid was added to the oligomer line before the LP along with cobalt as a toner. The antimony catalyst was added to the paste makeup in the PE. Detailed process conditions and measurement results are in Table 1.

TABLE 1

| Parameter | Value | Units |
|---|---|---|
| TA:EG mole ratio | 1.11:1 | |
| PE Temp | 265 | C. |
| PE Pressure | 3.5 | Barg |
| PE level | 80 | % |
| SE Temp | 270 | C. |
| SE Pressure | 960 | mBara |
| SE level | 40 | % |
| LP Temp | 280 | C. |
| LP Pressure | 50 | mBara |
| LP level | 60 | % |
| LP IV | 0.295 | dl/g |
| HP Temp | 280 | C. |
| HP Pressure | 3.9 | mBara |
| HP level | 55 | % |
| HP IV | 0.609 | dl/g |
| HP COOH | 27 | microeq/g |
| HP VEG | 0.012 | mol/100 rpt unit |
| HP AA | 42 | ppm |
| Sb | 280 | ppm |
| Ti | 0 | ppm |
| P | 7.5 | ppm |
| Co | 15 | ppm |
| Reheat Agent | 0 | ppm |
| L* | 65 | CIE |
| b* | 1.1 | CIE |
| SSP IV | 0.823 | dl/g |
| SSP b* | 0.23 | CIE |
| Arburg AA | 7.4 | ppm |
| Arburg b* | 3.05 | CIE |

### Comparative Example 2

In this example higher levels of phosphoric acid and cobalt were used relative to Comparative Example 1. The plant throughput was 20 kg/hour to keep the VEGs low by maintaining a low HP temperature as compared to Comparative Example 1. The antimony and phosphorous/cobalt addition points were the same as in

### Comparative Example 1

### Detailed Process Conditions and Measurement Results are in Table 2

TABLE 2

| Parameter | Value | Units |
|---|---|---|
| TA:EG mole ratio | 1.07:1 | |
| PE Temp | 260 | C. |
| PE Pressure | 3.5 | Barg |
| PE level | 40 | % |
| SE Temp | 265 | C. |
| SE Pressure | 960 | mBara |
| SE level | 30 | % |
| LP Temp | 270 | C. |
| LP Pressure | 60 | mBara |
| LP level | 50 | % |
| LP IV | 0.269 | dl/g |
| HP Temp | 270 | C. |
| HP Pressure | 1.2 | mBara |
| HP level | 55 | % |
| HP IV | 0.827 | dl/g |
| HP COOH | 23 | microeq/g |
| HP VEG | 0.006 | mol/100 rpt unit |
| HP AA | 35 | ppm |
| Sb | 280 | ppm |
| Ti | 0 | ppm |
| P | 30 | ppm |
| Co | 60 | ppm |
| Reheat Agent | 0 | ppm |
| L* | 60 | CIE |
| b* | 0.9 | CIE |
| Arburg AA | 8.2 | ppm |
| Arburg b* | 2.68 | CIE |

### Comparative Example 3

In this example a titanium catalyst system (PC64 available from DuPont) instead of antimony was used without late addition of phosphorous. The plant throughput was 20 kg/hour. Phosphorous (P) in the form of phosphoric acid was added to the oligomer line along with the cobalt toner as in the above Comparative Examples 1 and 2. The titanium catalyst was added to the paste makeup in the PE. Detailed process conditions and measurement results are in Table 3.

TABLE 3

| Parameter | Value | Units |
|---|---|---|
| TA:EG mole ratio | 1.07:1 | |
| PE Temp | 260 | C. |
| PE Pressure | 3.5 | Barg |
| PE level | 40 | % |
| SE Temp | 265 | C. |
| SE Pressure | 960 | mBara |
| SE level | 30 | % |
| LP Temp | 270 | C. |
| LP Pressure | 50 | mBara |
| LP level | 50 | % |
| LP IV | 0.276 | dl/g |
| HP Temp | 270 | C. |
| HP Pressure | 0.6 | mBara |
| HP level | 50 | % |
| HP IV | 0.832 | dl/g |
| HP COOH | 10.2 | microeq/g |
| HP VEG | 0.004 | mol/100 rpt unit |
| HP AA | 32 | ppm |
| Sb | 0 | ppm |
| Ti | 13 | ppm |
| P | 40 | ppm |
| Co | 80 | ppm |
| Reheat Agent | 0 | ppm |
| L* | 61.4 | CIE |
| b* | 2.6 | CIE |
| Arburg AA | 7.9 | ppm |
| Arburg b* | 7.56 | CIE |

### Example 4

In this example 40 ppm of triethyl phosphonoacetate (TEPA) was added to the polymer transfer line (late phosphorous addition). Cobalt and phosphorous in the form of phosphoric acid were also added to the oligomer as in the previous examples. The titanium catalyst (PC64 available from DuPont) concentration was 27 ppm to accommodate the higher plant throughput of 30 kg/hour for the same LP and HP process conditions. The titanium catalyst was added to the paste makeup in the PE. Detailed process conditions and measurement results are in Table 4.

TABLE 4

| Parameter | Value | Units |
|---|---|---|
| TA:EG mole ratio | 1.07:1 | |
| PE Temp | 260 | C. |
| PE Pressure | 3.5 | Barg |
| PE level | 75 | % |
| SE Temp | 265 | C. |
| SE Pressure | 960 | mBara |
| SE level | 30 | % |
| LP Temp | 270 | C. |
| LP Pressure | 50 | mBara |
| LP level | 50 | % |
| LP IV | 0.258 | dl/g |
| HP Temp | 270 | C. |
| HP Pressure | 0.1 | mBara |
| HP level | 50 | % |
| HP IV | 0.818 | dl/g |
| HP COOH | 11.4 | microeq/g |
| HP VEG | 0.002 | mol/100 rpt unit |
| HP AA | 28 | ppm |
| Sb | 0 | ppm |
| Ti | 27 | ppm |
| P | 80 | ppm |
| Co | 80 | ppm |
| Reheat Agent | 0 | ppm |
| L* | 60.3 | CIE |
| b* | 3.5 | CIE |
| Arburg AA | 3.9 | ppm |
| Arburg b* | 5.21 | CIE |

### Example 5

In this example 60 ppm of TEPA was added to the polymer transfer line. ‘Active’ cobalt acetate was added to the oligomer line without phosphorous. The plant rate is 30 kg/hour. The titanium catalyst (PC64 available from DuPont) concentration was 18 ppm. The HP pressure was higher than Comparative Example 3 and Example 4 as a consequence of the active (catalytic) cobalt. The titanium catalyst was added to the paste makeup in the PE. Detailed process conditions and measurement results are in Table 5.

TABLE 5

| Parameter | Value | Units |
|---|---|---|
| TA:EG mole ratio | 1.07:1 | |
| PE Temp | 260 | C. |
| PE Pressure | 3.5 | Barg |
| PE level | 75 | % |
| SE Temp | 265 | C. |
| SE Pressure | 960 | mBara |
| SE level | 30 | % |
| LP Temp | 270 | C. |
| LP Pressure | 50 | mBara |
| LP level | 50 | % |
| LP IV | 0.286 | dl/g |
| HP Temp | 270 | C. |
| HP Pressure | 1.1 | mBara |
| HP level | 50 | % |
| HP IV | 0.824 | dl/g |
| HP COOH | 16.8 | microeq/g |
| HP VEG | 0.008 | mol/100 rpt unit |
| HP AA | 36 | ppm |
| Sb | 0 | ppm |
| Ti | 18 | ppm |
| P | 100 | ppm |
| Co | 80 | ppm |
| Reheat Agent | 0 | ppm |
| L* | 58.6 | CIE |
| b* | 1.5 | CIE |
| Arburg AA | 5 | ppm |
| Arburg b* | 6.64 | CIE |

### Example 6

In this example 100 ppm of tributyl phosphate (TBP) was added to the polymer transfer line. “Active” cobalt acetate was added to the oligomer line. The plant rate was 40 kg/hour resulting from the HP temperature of 280 C. The titanium catalyst (PC64 available from DuPont) concentration was 18 ppm. The titanium catalyst was added to the paste makeup in the PE. A reheat agent was added hence the reduction in L* color. Detailed process conditions and measurement results are in Table 6.

TABLE 6

| Parameter | Value | Units |
|---|---|---|
| TA:EG mole ratio | 1.1:1 | |
| PE Temp | 265 | C. |
| PE Pressure | 3.5 | Barg |
| PE level | 80 | % |
| SE Temp | 270 | C. |
| SE Pressure | 960 | mBara |
| SE level | 40 | % |
| LP Temp | 270 | C. |
| LP Pressure | 50 | mBara |
| LP level | 50 | % |
| LP IV | 0.264 | dl/g |
| HP Temp | 280 | C. |
| HP Pressure | 1 | mBara |
| HP level | 50 | % |
| HP IV | 0.813 | dl/g |
| HP COOH | 21 | microeq/g |
| HP VEG | 0.014 | mol/100 rpt unit |
| Sb | 0 | ppm |
| Ti | 18 | ppm |
| P | 100 | ppm |
| Co | 80 | ppm |
| Reheat Agent | 2 | ppm |
| (carbon black) | | |
| L* | 54.7 | CIE |
| b* | 3.2 | CIE |
| Arburg AA | 2.9 | ppm |
| Arburg b* | 7.6 | CIE |

### Example 7

In this example 100 ppm of TEPA was added to the polymer transfer line. “Active” cobalt acetate was added to the oligomer line. The plant rate was 40 kg/hour resulting from the HP temperature of 280 C. The titanium catalyst (PC64 available from DuPont) concentration was 18 ppm. The titanium catalyst was added to the paste makeup in the PE. A reheat agent was added hence the reduction in L* color. Detailed process conditions and measurement results are in Table 7.

TABLE 7

| Parameter | Value | Units |
|---|---|---|
| TA:EG mole ratio | 1.1:1 | |
| PE Temp | 265 | C. |
| PE Pressure | 3.5 | Barg |
| PE level | 80 | % |
| SE Temp | 270 | C. |
| SE Pressure | 960 | mBara |
| SE level | 40 | % |
| LP Temp | 270 | C. |
| LP Pressure | 50 | mBara |
| LP level | 50 | % |
| LP IV | 0.264 | dl/g |
| HP Temp | 280 | C. |
| HP Pressure | 1.3 | mBara |
| HP level | 50 | % |
| HP IV | 0.805 | dl/g |
| HP COOH | 18.3 | microeq/g |
| HP VEG | 0.014 | mol/100 rpt unit |
| Sb | 0 | ppm |
| Ti | 18 | ppm |
| P | 100 | ppm |
| Co | 80 | ppm |
| Reheat Agent | 2 | ppm |
| (carbon black) | | |
| L* | 56 | CIE |
| b* | 5.2 | CIE |
| Arburg AA | 2.8 | ppm |
| Arburg b* | 8.8 | CIE |

### Example 8

In this example 70 ppm Zn and 12 ppm of titanium and dyes as toners were used while using late addition of a phosphorous compound to the polymer transfer line with high IV MPP. Zinc acetate (Zn) was used as the co-catalyst with titanium (PC64 available from DuPont). The dyes used were Clariant Polysynthrin Blue RLS and Red 5B. The phosphorous compound was tributyl phosphate (TBP). Plant throughput was 40 kg/hour at 280 C in the HP. The co-catalyst was added to the paste makeup in the PE. Detailed process conditions and measurement results are in Table 8.

TABLE 8

| Parameter | Value | Units |
|---|---|---|
| TA:EG mole ratio | 1.1:1 | |
| PE Temp | 265 | C. |
| PE Pressure | 3.5 | Barg |
| PE level | 80 | % |
| SE Temp | 270 | C. |
| SE Pressure | 960 | mBara |
| SE level | 40 | % |
| LP Temp | 270 | C. |
| LP Pressure | 50 | mBara |
| LP level | 50 | % |
| LP IV | 0.264 | dl/g |
| HP Temp | 280 | C. |
| HP Pressure | 0.2 | mBara |
| HP level | 50 | % |
| HP IV | 0.792 | dl/g |
| HP COOH | 29.3 | microeq/g |
| HP VEG | 0.016 | mol/100 rpt unit |
| Sb | 0 | ppm |
| Ti | 12 | ppm |
| Zn | 70 | ppm |
| P | 100 | ppm |
| Co | 0 | ppm |
| Blue RLS | 5.8 | ppm |
| Red 5B | 1.2 | ppm |
| Reheat Agent | 2 | ppm |
| (carbon black) | | |
| L* | 55.8 | CIE |
| b* | 1.5 | CIE |
| Arburg AA | 4.1 | ppm |
| Arburg b* | 4.93 | CIE |
| NB90 AA | 9.9 | ppm |
| NB90 b* | 3.32 | CIE |

The NB90 machine gives a significantly higher preform AA value as a consequence of its longer cycle time.

### Example 9

In this example 60 ppm of polyphosphoric acid (PPA) was added to the polymer transfer line. “Active” cobalt acetate was added to the oligomer line. The plant rate was 40 kg/hour resulting from the HP temperature of 280 C. The titanium catalyst (PC64 available from DuPont) concentration was 18 ppm. The titanium catalyst was added to the paste makeup in the PE. A reheat agent was added hence the reduction in L* color. Detailed process conditions and measurement results are in Table 9.

TABLE 9

| Parameter | Value | Units |
|---|---|---|
| TA:EG mole ratio | 1.1:1 | |
| PE Temp | 265 | C. |
| PE Pressure | 3.5 | Barg |
| PE level | 80 | % |
| SE Temp | 270 | C. |
| SE Pressure | 960 | mBara |
| SE level | 40 | % |
| LP Temp | 270 | C. |
| LP Pressure | 50 | mBara |
| LP level | 50 | % |
| LP IV | 0.264 | dl/g |
| HP Temp | 280 | C. |
| HP Pressure | 1.3 | mBara |
| HP level | 50 | % |
| HP IV | 0.824 | dl/g |
| HP COOH | 20.7 | microeq/g |
| HP VEG | 0.014 | mol/100 rpt unit |
| Sb | 0 | ppm |
| Ti | 18 | ppm |
| P | 60 | ppm |
| Co | 80 | ppm |
| Reheat Agent | 2 | ppm |
| (carbon black) | | |
| L* | 54.8 | CIE |
| b* | 5.8 | CIE |
| NB90 AA | 6.79 | ppm |
| NB90 b* | 6.93 | CIE |

The AA value was better than Comparative Examples 1-3, by cross reference to the data in Example 8.

### Example 10

In this example 70 ppm Zn and 18 ppm of titanium and dyes as toners were used while using late addition of a phosphorous compound to the polymer transfer line with high IV MPP. Zinc acetate (Zn) was used as the co-catalyst with titanium (PC64 available from DuPont). The dyes used were Clariant Polysynthrin Blue RLS and Red 5B. The phosphorous compound was a P(III) phosphite, namely triphenyl phosphite. Plant throughput was 40 kg/hour at 275 C in the HP. The co-catalyst catalyst was added to the paste makeup in the PE. Detailed process conditions and measurement results are in Table 10.

TABLE 10

| Parameter | Value | Units |
|---|---|---|
| TA:EG mole ratio | 1.2:1 | |
| PE Temp | 265 | C. |
| PE Pressure | 3.5 | Barg |
| PE level | 80 | % |
| SE Temp | 270 | C. |
| SE Pressure | 960 | mBara |
| SE level | 40 | % |
| LP Temp | 270 | C. |
| LP Pressure | 50 | mBara |
| LP level | 50 | % |
| LP IV | 0.292 | dl/g |
| HP Temp | 275 | C. |
| HP Pressure | 2.6 | mBara |
| HP level | 50 | % |
| HP IV | 0.826 | dl/g |
| HP COOH | 18.3 | microeq/g |
| HP VEG | 0.008 | mol/100 rpt unit |
| HP AA | 52 | ppm |
| Sb | 0 | ppm |
| Ti | 18 | ppm |
| Zn | 70 | ppm |
| P | 160 | ppm |
| Co | 0 | ppm |
| Blue RLS | 8.4 | ppm |
| Red 5B | 2.0 | ppm |
| Reheat Agent | 2 | ppm |
| (carbon black) | | |
| L* | 52.5 | CIE |
| b* | 0.4 | CIE |
| NB90AA | 7.51 | ppm |
| NB90 b* | 1.2 | CIE |

The AA value was better than Comparative Examples 1-3, by cross reference to the data in Example 8.

### Example 11

In this example 260 ppm of Zn and dyes as toners were used while using late addition of a phosphorous compound to the polymer transfer line with high IV MPP. Zinc acetate (Zn) was used as the only catalyst. The dyes used were Clariant Polysynthrin Blue RLS and Red 5B. The phosphorous compound was tributyl phosphate (TBP). Plant throughput was 40 kg/hour at 275 C in the HP. The zinc catalyst was added to the paste makeup in the PE. Detailed process conditions and measurement results are in Table 11.

TABLE 11

| Parameter | Value | Units |
|---|---|---|
| TA:EG mole ratio | 1.1:1 | |
| PE Temp | 265 | C. |
| PE Pressure | 3.5 | Barg |
| PE level | 80 | % |
| SE Temp | 270 | C. |
| SE Pressure | 960 | mBara |
| SE level | 40 | % |
| LP Temp | 270 | C. |
| LP Pressure | 50 | mBara |
| LP level | 50 | % |
| LP IV | 0.288 | dl/g |
| HP Temp | 275 | C. |
| HP Pressure | 0.2 | mBara |
| HP level | 50 | % |
| HP IV | 0.786 | dl/g |
| HP COOH | 51.4 | microeq/g |
| HP VEG | 0.042 | mol/100 rpt unit |
| HP AA | 54 | ppm |
| Sb | 0 | ppm |
| Ti | 0 | ppm |
| Zn | 260 | ppm |
| P | 160 | ppm |
| Co | 0 | ppm |
| Blue RLS | 4.9 | ppm |
| Red 5B | 1.1 | ppm |
| Reheat Agent | 2 | ppm |
| (carbon black) | | |
| L* | 58.1 | CIE |
| b* | −6.0 | CIE |
| NB90AA | 3.2 | ppm |
| NB90 b* | −3.11 | CIE |

While the invention has been described in conjunction with specific embodiments thereof, it is evident that the many alternatives, modifications, and variations will be apparent to those skilled in the art in light of the foregoing description. Accordingly, the invention is intended to embrace all such alternatives, modifications and variations as fall within the spirit and scope of the claims.

What is claimed is:

1. A process for producing a polyester comprising:
(a) forming a polyester with an intrinsic viscosity of about 0.65 or more, wherein said forming of the polyester comprises use of a catalyst; and
(b) adding a phosphorous compound to the polyester after the forming of step (a), wherein said phosphorous compound comprises at least one member selected from the group consisting of trialkyl phosphate, trialkyl phosphonoacetate, monoalkyl phosphate, dialkyl phosphate, trialkyl phosphite, triaryl phosphite, tris alkylaryl phosphite, and mixtures thereof.

2. The process of claim 1 wherein said phosphorous compound comprises at least one member selected from the group consisting of tributyl phosphate, triethyl phosphate, triethyl phosphonoacetate, monoethyl phosphate, diethyl phosphate, triethyl phosphite, triphenyl phosphite, tris nonylphenyl phosphite, and mixtures thereof.

3. The process of claim 1 wherein said phosphorous compound comprises at least one member selected from the group consisting of triphenyl phosphite, triethyl phosphite, triethyl phosphonoacetate and mixtures thereof.

4. The process of claim 1 wherein the catalyst comprises at least one member selected from the group consisting of antimony, titanium, cobalt, germanium, aluminum, tin, zinc and mixtures thereof.

5. The process of claim 1 wherein the catalyst comprises at least one member selected from the group consisting of titanium, cobalt, germanium, aluminum, tin, zinc and mixtures thereof.

6. The process of claim 1 wherein the catalyst comprises at least one member selected from the group consisting of titanium, cobalt, zinc and mixtures thereof.

7. The process of claim 6 wherein said catalyst comprises a mixture of titanium and zinc.

8. The process of claim 7 wherein the titanium and the zinc are present at a titanium to zinc weight ratio in the range of from about 1:60 to about 1:2.

9. The process of claim 7 wherein the titanium is present at a concentration in the range of from about 3 ppm to about 20 ppm by weight of the polyester.

10. The process of claim 7 wherein the zinc is present at a concentration in the range of from about 60 ppm to about 250 ppm by weight of the polyester.

11. The process of claim 1 wherein the phosphorous compound and the catalyst are present at a weight phosphorous compound to weight catalyst ratio in the range of from about 0.5:1 to about 5.75:1.

12. The process of claim 11 wherein said weight phosphorous compound to weight catalyst ratio is in the range of from about 0.5:1 to about 4:1.

13. The process of claim 11 wherein said weight phosphorous compound to weight catalyst ratio is in the range of from about 0.75:1 to about 1.5:1.

14. The process of claim 11 wherein said weight phosphorous compound to weight catalyst ratio is about 1:1.

15. The process of claim 1 wherein said intrinsic viscosity is about 0.70 or more.

16. The process of claim 1 wherein said intrinsic viscosity is about 0.75 or more.

17. The process of claim 1 wherein said intrinsic viscosity is about 0.80 or more.

18. The process of claim 1 wherein said forming of step (a) comprises melt phase polymerization.

19. The process of claim 1 wherein said polyester has an L* of about 50 or more after the adding of step (b).

20. The process of claim 1 wherein said polyester has an L* of about 54 or more after the adding of step (b).

21. The process of claim 1 further comprising adding a reheat agent to the polyester.

22. The process of claim 21 wherein the reheat agent is at least one member selected from the group consisting of carbon black, graphite, infra-red dye, metal particle and mixtures thereof.

23. The process of claim 21 wherein the reheat agent is at least one member selected from the group consisting of antimony, titanium, copper, manganese, iron, tungsten and mixtures thereof.

24. The process of claim 21 wherein the reheat agent is present in a concentration range of from about 0.5 ppm to about 20 ppm by weight.

25. The process of claim 1 wherein said polyester is made by the polycondensation of a diol and a diacid; said diol is selected from the group consisting of ethylene glycol, 1,3-propane diol, 1,4- butane diol or 1,4-cyclohexanedimethanol; and said diacid is selected from the group consisting of terephthalic acid, isophthalic acid and 2,6-naphthoic acid.

26. The process of claim 25 wherein said polyester is at least one member selected from the group consisting of polyethylene terephthalate, polyethylene naphthalate, polyethylene isophthalate, polybutylene terephthalate, copolyesters of polyethylene terephthalate, copolyesters of polyethylene naphthalate, copolyesters of polyethylene isophthalate, copolyesters of polybutylene terephthalate and mixtures thereof.

27. The process of claim 26 wherein said polyester is polyethylene terephthalate or a copolyester of polyethylene terephthalate with up to 20 wt-% of isophthalic acid or 2,6-naphthoic acid, and up to 10 wt-% of diethylene glycol or 1,4-cyclohexanedimethanol.

28. The process of claim 26 wherein said polyester is polybutylene terephthalate or a copolyester of polybutylene terephthalate with up to 20 wt-% of a dicarboxylic acid, and up to 20 wt-% of ethylene glycol or 1,4-cyclohexanedimethanol.

29. The process of claim 26 wherein said polyester is polyethylene naphthalate or a copolyester of polyethylene naphthalate with up to 20 wt-% of isophthalic acid, and up to 10 wt-% of diethylene glycol or 1,4-cyclohexanedimethanol.

30. The process of claim 1 further comprising adding an additive.

31. The process of claim 30 wherein the additive comprises at least one member selected from the group consisting of a heat stabilizer, an anti-blocking agent, an antioxidant, an antistatic agent, a UV absorber, a pigment, a dye, a filler, a branching agent and mixtures thereof.

32. A polyester composition produced by the process of claim 1.

33. An article comprising a composition produced by the process of claim 1.
